(19) United States
(12) Patent Application Publication
(10) Pub. No.: US 2015/0007248 A1
(43) Pub. Date: Jan. 1, 2015

(54) BROADCAST RECEIVER, BROADCAST RECEIVING MODULE, AND METHOD FOR CONTROLLING ENERGIZATION

(71) Applicant: Kabushiki Kaisha Toshiba, Tokyo (JP)

(72) Inventor: Takuji KIMURA, Ome-shi Tokyo (JP)

(73) Assignee: Kabushiki Kaisha Toshiba, Tokyo (JP)

(21) Appl. No.: 14/283,534

(22) Filed: May 21, 2014

Related U.S. Application Data
(63) Continuation of application No. PCT/JP2013/067664, filed on Jun. 27, 2013.

(51) Int. Cl. H04N 21/6332; H04N 21/84; H04N 21/426

(52) U.S. Cl. CPC H04N 21/6332; H04N 21/426; H04N 21/84
USPC 725/151

(57) ABSTRACT

According to one embodiment, a broadcast receiver is a device to which a broadcast receiving module comprising a receiver that receives a broadcast signal is detachably attached. The broadcast receiver has a power source and a controller. The power source is configured to supply electric power to the broadcast receiving module. The controller is configured to perform, when energization control information containing identification information and time information is received, energization control on the broadcast receiving module identified by the identification information based on the time information. The identification information is configured to be unique to the broadcast receiving module. The time information is configured to relate to power supply to the broadcast receiving module.

### CROSS-REFERENCE TO RELATED APPLICATIONS

This application is a continuation of international application No. PCT/JP2013/067664, filed Jun. 27, 2013, which designates the United States, the entire contents of which are incorporated herein by reference.

### FIELD

An embodiment described herein relates generally to a broadcast receiver, a broadcast receiving module, and a method for controlling energization.

### BACKGROUND

Conventionally, there has been known a broadcast receiver comprising a receiver that receives broadcast signals and a power source that supplies electric power to the receiver.

Typically, pay broadcasting services and the like transmit control information, such as renewal of a contract, as individual information in a state multiplexed on broadcast signals. Such control information (individual information) is transmitted independently of a timing of a user for viewing a program. To appropriately acquire the control information independently of a timing at which the user turns ON a broadcast receiver to view a program, it is desirable to control energization to the broadcast receiver. Efficient reception of the control information, such as renewal of a contract, is preferably achieved in terms of both smooth renewal of a contract, that is, convenience for the user and power saving.

To support a plurality of broadcasting services or expand the functions in the future, receivers may be modularized individually for the respective broadcasting services. The broadcast receiving modules are detachably (replaceably) attached to the broadcast receiver main body. Also in this case, it is preferable that energization (power supply) be performed efficiently at a necessary timing for the broadcast receiving modules.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram illustrating an entire configuration of a television device according to an embodiment;

FIG. 2 is an exemplary block diagram illustrating an internal configuration of the television device in the embodiment;

FIG. 3 is an exemplary diagram illustrating an energization information table stored in a memory of an device main body of the television device in the embodiment;

FIG. 4 is an exemplary flowchart of a processing flow performed when energization control information is received by the device main body of the television device in the embodiment; and

FIG. 5 is an exemplary flowchart of a processing flow performed when a controller of the device main body of the television device in the embodiment performs energization control on a broadcast receiving module.

### DETAILED DESCRIPTION

In general, according to one embodiment, a broadcast receiver is a device to which a broadcast receiving module comprising a receiver that receives a broadcast signal is detachably attached. The broadcast receiver has a power source and a controller. The power source is configured to supply electric power to the broadcast receiving module. The controller is configured to perform, when energization control information containing identification information and time information is received, energization control on the broadcast receiving module identified by the identification information based on the time information. The identification information is configured to be unique to the broadcast receiving module. The time information is configured to relate to power supply to the broadcast receiving module.

Exemplary embodiments are described below with reference the accompanying drawings.

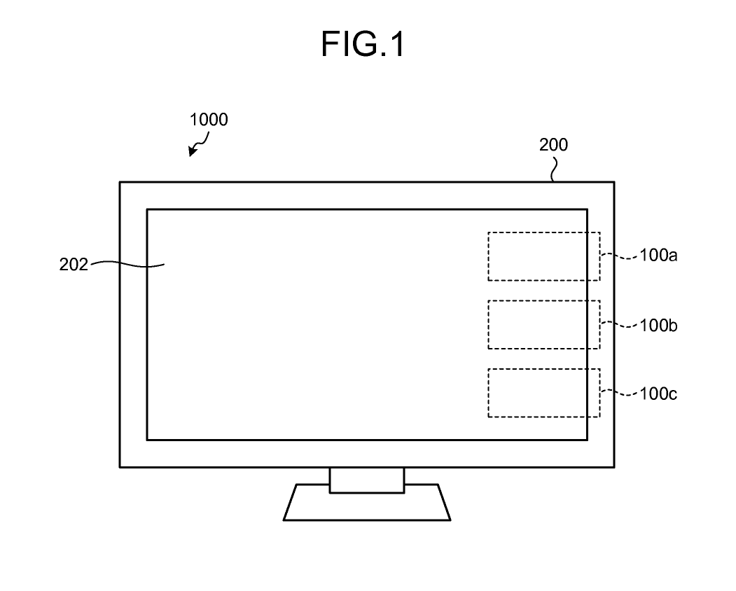

The following describes a configuration of a television device 1000 according to an embodiment with reference to FIG. 1 to FIG. 4. The television device 1000 is an example of a “broadcast receiver”.

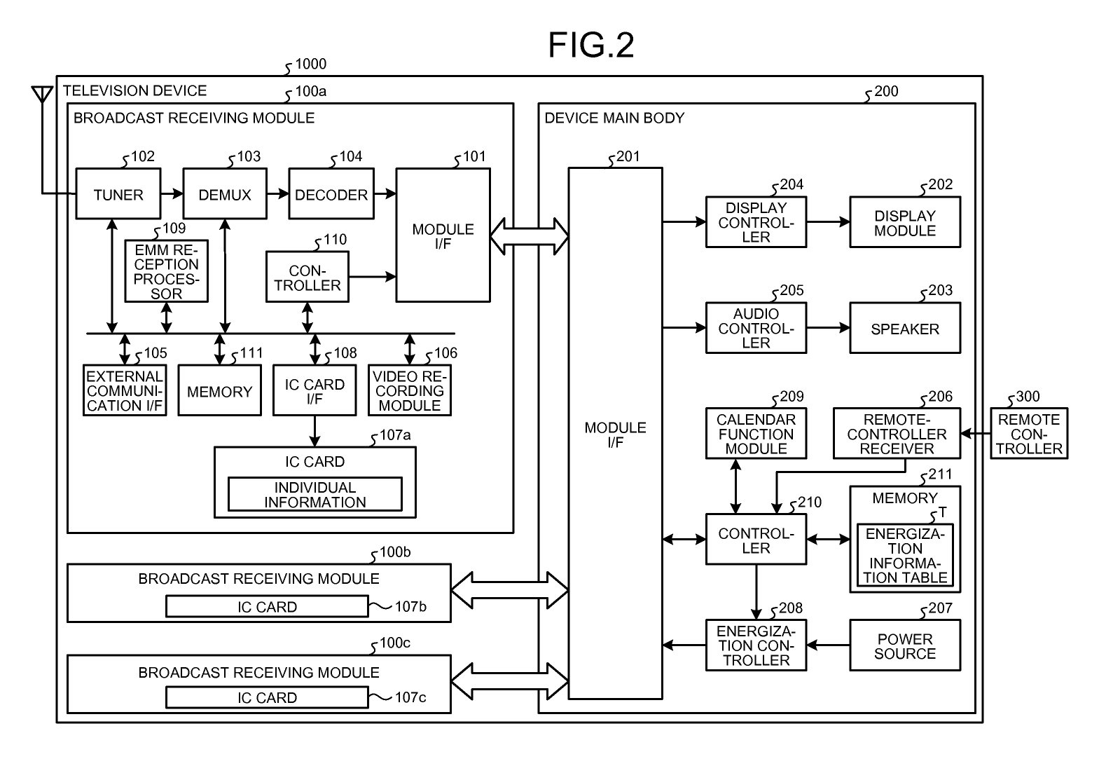

As illustrated in FIG. 1 and FIG. 2, the television device 1000 comprises an device main body 200 having a display module 202 and a plurality of (three) broadcast receiving modules 100a, 100b, and 100c.

The broadcast receiving modules 100a, 100b, and 100c are detachably (replaceably) attached to the device main body 200. Because the broadcast receiving modules 100a, 100b, and 100c have the same configuration except for integrated circuit (IC) cards 107a, 107b, and 107c (refer to FIG. 2), which will be described later, the following mainly describes the broadcast receiving module 100a. According to this configuration in which the broadcast receiving modules 100a, 100b, and 100c are detachably attached to the device main body 200, it is possible to provide the television device 1000 that supports various types of reception environments depending on areas and usage.

As illustrated in FIG. 2, the broadcast receiving module 100a comprises a module interface (I/F) 101, a tuner 102, a demultiplexer (DEMUX) 103, a decoder 104, and an external communication I/F 105. The tuner 102 is an example of a “receiver”. The broadcast receiving module 100a further comprises a video recording module 106, the IC card 107a, a IC card I/F 108, an entitlement management message (EMM) reception processor 109, a controller 110, and a memory 111. The controller 110 is an example of an “output module”.

The module I/F 101 functions as an interface used to attach the broadcast receiving module 100a to the device main body 200. The tuner 102 has a function to receive broadcast signals transmitted from broadcasting stations (not illustrated). The broadcasting stations provide pay broadcasting services and pay-per-view (PPV) services for which a viewing contract is made by a user, for example. The broadcast signals transmitted from the broadcasting stations contain individual information depending on the contents of the contract made by the user. The individual information is individual data for the broadcast receiving module 100a (100b or 100c). The individual information is EMM data, such as data of a viewing contract of pay broadcast and control information indicating an acquisition timing of viewing history information of PPV programs.

The individual information is not always multiplexed on the broadcast signals but multiplexed on the broadcast signals at a predetermined timing when renewal of a contract is made, for example. Thus, the broadcast signals also contain time information indicating a timing at which the individual information is transmitted and received in a state multiplexed on the broadcast signals. Specifically, the broadcast signals contain a start time and an end time of transmission and reception of the individual information as the time information. In the embodiment, the broadcast receiving module 100a (100b or 100c) is configured to output, every time the time information is received, the received time information and module identification information unique to the broadcast receiving module 100a (100b or 100c) to the device main body 200.

The DEMUX 103 has a function to distribute signals output from the tuner 102. The decoder 104 has a function to decode a signal output from the DEMUX 103. The external communication I/F 105 has a function to perform network communications with the outside. The video recording module 106 comprises a hard disk drive (HDD), for example, and has a function to record a program corresponding to broadcast signals received by the tuner 102.

The IC card 107a stores therein an ID unique to the IC card 107a and EMM data. The IC card 107a is provided in a manner detachable from the IC card I/F 108. The EMM reception processor 109 has a function to receive EMM data.

The controller 110 performs control on each module of the broadcast receiving module 100a. The controller 110, for example, performs control for outputting the module identification information and the time information to the device main body 200 so as to cause the device main body 200 to perform energization control (described later in detail) on the broadcast receiving module 100a. The memory 111 stores therein various types of computer programs executed by the controller 110 and various types of data used to execute the various types of computer programs.

As illustrated in FIG. 2, the device main body 200 comprises a module I/F 201, the display module 202, a speaker 203, a display controller 204, and an audio controller 205. The device main body 200 further comprises a remote-controller receiver 206, a power source 207, an energization controller 208, a calendar function module 209, a controller 210, and a memory 211. The calendar function module 209 is an example of a “time measuring module”, and the memory 211 is an example of a “storage module”.

The module I/F 201 functions as an interface used to attach the broadcast receiving module 100a (100b or 100c). The display module 202 displays video corresponding to the broadcast signals received by the tuner 102 of the broadcast receiving module 100a (100b or 100c). The speaker 203 outputs audio corresponding to the video displayed by the display module 202. The display module 202 and the speaker 203 operate based on control of the display controller 204 and the audio controller 205, respectively.

The remote-controller receiver 206 receives a remote-control signal transmitted from a remote-controller 300 that operates the television device 1000. The remote-controller 300 is an example of an “operating module”. The power source 207 supplies electric power to each of the broadcast receiving modules 100a, 100b, and 100c. The power source 207 operates based on control performed by the energization controller 208.

The calendar function module 209 has a function to measure a current time (first current time). The controller 210 performs control on each module of the device main body 200. The memory 211 stores therein various types of computer programs executed by the controller 210 and various types of data (e.g., an energization information table T, which will be described later) used to execute the various types of computer programs.

In the present embodiment, if the time information and the module identification information are received from the broadcast receiving module 100a (100b or 100c), the controller 210 (energization controller 208) performs energization control on the broadcast receiving module 100a (100b or 100c) identified by the module identification information based on the time information. The time information and the module identification information are used to perform energization control on the broadcast receiving module 100a (100b or 100c). The time information and the module identification information are hereinafter referred to as energization control information.

The energization control information contains the start time and the end time of transmission and reception of the individual information as described above. Thus, the controller 210 performs, upon receiving the energization control information from the broadcast receiving module 100a (100b or 100c), control for starting power supply to the broadcast receiving module 100a (100b or 100c) based on the start time contained in the energization control information. In addition, the controller 210 performs, upon receiving the energization control information from the broadcast receiving module 100a (100b or 100c), control for stopping power supply to the broadcast receiving module 100a (100b or 100c) based on the end time contained in the energization control information.

More specifically, if the first current time measured by the calendar function module 209 reaches the start time, the controller 210 performs control for starting power supply to the broadcast receiving module 100a (100b or 100c). If the first current time reaches the end time, the controller 210 performs control for stopping power supply to the broadcast receiving module 100a (100b or 100c).

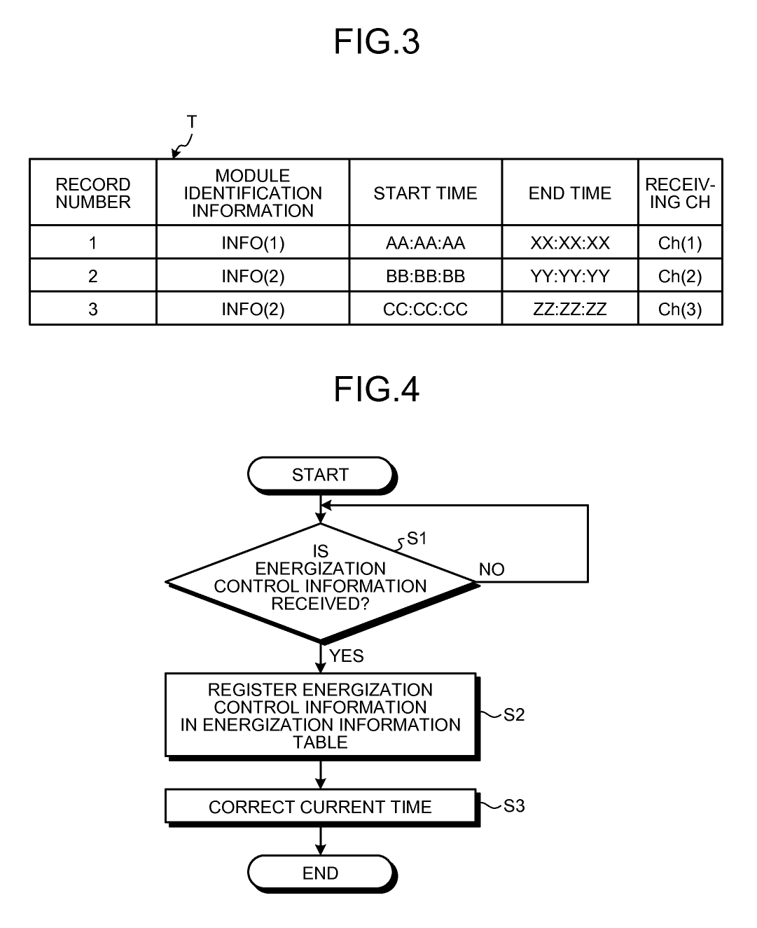

In the present embodiment, upon receiving the energization control information from the broadcast receiving module 100a (100b or 100c), the controller 210 registers the received energization control information in the energization information table T stored in the memory 211. Based on the energization control information registered in the energization information table T, the controller 210 performs control for starting or stopping power supply to the broadcast receiving module 100a (100b or 100c). An example of the data structure of the energization information table T will be briefly described with reference to FIG. 3.

As illustrated in FIG. 3, the energization information table T stores therein a record number, module identification information, a start time, an end time, and a receiving channel (CH) in a manner associated with one another as the energization control information. The record number is a number assigned for convenience to manage a plurality of pieces of energization control information individually. FIG. 3 illustrates numbers of “1”, “2”, and “3” as examples of the record number. The module identification information is information for distinguishing the broadcast receiving modules 100a, 100b, and 100c. The module identification information is information unique to each module. The same type of modules that can receive the same type of broadcast signals, for example, have different module identification information. FIG. 3 illustrates pieces of information of “INFO(1) ” and “INFO(2)” as examples of the module identification information.

The start time is time to start energization (power supply) to the broadcast receiving module 100a (100b or 100c) as described above. In other words, the start time is a start time of transmission and reception of the individual information. FIG. 3 illustrates time of “AA:AA:AA”, “BB:BB:BB”, and “CC:CC:CC” as examples of the start time. The end time is time to stop energization to the broadcast receiving module 100a (100b or 100c) as described above. In other words, the end time is an end time of transmission and reception of the individual information. FIG. 3 illustrates time of “XX:XX:XX”, “YY:YY:YY”, and “ZZ:ZZ:ZZ” as examples of the end time. The receiving channel is information indicating a channel of a program for which a viewing contract is made by the user. FIG. 3 illustrates channels of “Ch(1)”, “Ch(2)”, and “Ch(3)” as examples of the receiving channel.

As described above, in the present embodiment, the energization control information comprises a plurality pieces of energization control information for each of the broadcast receiving modules 100a, 100b, and 100c (for respective receiving channels for which a viewing contract is made by the user). Based on the plurality pieces of energization control information, the controller 210 performs control for starting or stopping power supply to the broadcast receiving modules 100a, 100b, and 100c individually.

In the present embodiment, if the user makes a video recording reservation of a program, the broadcast receiving module 100a (100b or 100c) outputs the start time and the end time of the video recording performed by the video recording module 106 as the energization control information. Based on the start time (end time) of the video recording contained in the energization control information, the controller 210 performs control for starting (stopping) power supply to the broadcast receiving module 100a (100b or 100c).

In the present embodiment, if the broadcast receiving module 100a (100b or 100c) measures a current time (second current time) independently of the calendar function module 209 of the device main body 200, the broadcast receiving module 100a (100b or 100c) outputs the energization control information containing the second current time. Based on the second current time measured by the broadcast receiving module 100a (100b or 100c), the controller 210 of the device main body 200 performs control for correcting the first current time measured by the calendar function module 209. The correction of the first current time may be performed based on the current time contained in the broadcast signals.

In the present embodiment, an operation performed by the user (an operation with the remote-controller 300) can start or stop power supply to the broadcast receiving module 100a (100b or 100c). The controller 210 performs control for starting (stopping) power supply to the broadcast receiving module 100a (100b or 100c) based on the received energization control information regardless of the operation performed by the user.

The following describes an example of a processing flow performed when energization control information is received by the controller 210 of the device main body 200 of the television device 1000 according to the present embodiment with reference to FIG. 4. In the processing flow, the energization control information contains the current time (second current time) measured by the broadcast receiving module 100a (100b or 100c).

As illustrated in FIG. 4, the processing flow starts with processing for determining whether energization control information is received from the broadcast receiving module 100a (100b or 100c) at S1. The processing at S1 is repeated until it is determined that energization control information is received. If it is determined that energization control information is received, the processing proceeds to S2. Energization control information is output from the broadcast receiving module 100a (100b or 100c) to the device main body 200 when the broadcast receiving module 100a (100b or 100c) receives time information indicating a timing of transmission and reception of individual information transmitted and received in a state multiplexed on the broadcast signals.

The energization control information received from the broadcast receiving module 100a (100b or 100c) is registered in the energization information table T (refer to FIG. 3) at S2. If the energization information table T is yet to be created (if no energization information table T is stored in the memory 211), an energization information table T is newly created. If the energization control information received from the broadcast receiving module 100a (100b or 100c) and the energization control information already registered in the energization information table T have the same module identification information (refer to the second column from the left in FIG. 3) and the same receiving channel (refer to the rightmost column in FIG. 3), the energization control information already registered in the energization information table T is updated with the energization control information thus received. The processing then proceeds to S3.

Based on the second current time contained in the energization control information received from the broadcast receiving module 100a (100b or 100c), the first current time measured by the calendar function module 209 of the device main body 200 is corrected at S3. The processing is then terminated.

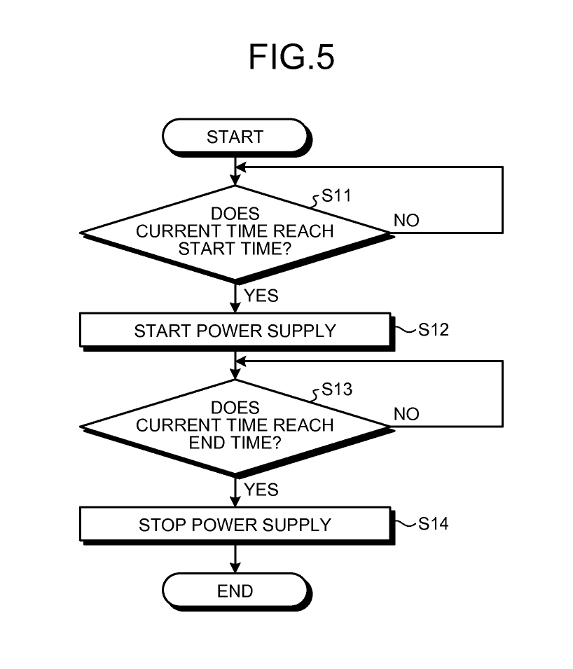

The following describes an example of a processing flow performed when the controller 210 (energization controller 208) of the device main body 200 of the television device 1000 according to the present embodiment performs energization control on the broadcast receiving module 100a (100b or 100c) with reference to FIG. 5.

The processing flow starts with processing for determining whether the current time measured by the calendar function module 209 reaches the start time (refer to the third column from the right in FIG. 3) registered in the energization information table T at S11. The processing at S11 is repeated until it is determined that the current time reaches the start time. If it is determined that the current time reaches the start time, the processing proceeds to S12.

Energization (power supply from the power source 207) to the broadcast receiving module 100a (100b or 100c) having the module identification information (refer to the second column from the left in FIG. 3) that the current time reaches the start time is started at S12. The processing then proceeds to S13.

It is determined whether the current time measured by the calendar function module 209 reaches the end time (refer to the second column from the right in FIG. 3) registered in the energization information table T at S13. The processing at S13 is repeated until it is determined that the current time reaches the end time. If it is determined that the current time reaches the end time, the processing proceeds to S14.

Energization (power supply from the power source 207) to the broadcast receiving module 100a (100b or 100c) having the module identification information (refer to the second column from the left in FIG. 3) that the current time reaches the end time is stopped at S14. The processing is then terminated.

As described above, upon receiving the energization control information containing the module identification information unique to the broadcast receiving module 100a (100b or 100c) and the time information relating to power supply to the broadcast receiving module 100a (100b or 100c) from the broadcast receiving module 100a (100b or 100c), the controller 210 (energization controller 208) performs energization control on the broadcast receiving module 100a (100b or 100c) identified by the module identification information based on the time information in the present embodiment. This makes it possible to perform energization (power supply) efficiently at a necessary timing for the broadcast receiving module 100a (100b or 100c), for example.

More specifically, it is possible to start power supply to the broadcast receiving module 100a (100b or 100c) at a timing to start transmission and reception of the individual information based on the time information (information indicating a timing at which the individual information is transmitted and received in a manner contained in the broadcast signals). This enables the broadcast receiving module 100a (100b or 100c) to efficiently receive the individual information corresponding thereto. Furthermore, it is possible to stop power supply to the broadcast receiving module 100a (100b or 100c) at a timing to stop transmission and reception of the individual information based on the time information. This makes it possible to stop power supply to the broadcast receiving module 100a (100b or 100c) at an unnecessary timing other than the timing to transmit and receive the individual information. As a result, power saving can be achieved in the television device 1000.

In the present embodiment, the energization control information comprises a plurality pieces of energization control information for each of the broadcast receiving modules 100a, 100b, and 100c (for respective receiving channels for which a viewing contract is made by the user) as described above. Based on the pieces of energization control information, the controller 210 performs control for starting or stopping power supply to the broadcast receiving modules 100a, 100b, and 100c individually. This makes it possible to perform energization efficiently at respective necessary timings for the broadcast receiving modules 100a, 100b, and 100c, for example.

In the present embodiment, upon receiving the energization control information from the broadcast receiving module 100a (100b or 100c), the controller 210 registers the received energization control information in the energization information table T stored in the memory 211 as described above. Based on the energization control information registered in the energization information table T, the controller 210 performs control for starting or stopping power supply to the broadcast receiving module 100a (100b or 100c). This can facilitate performing energization at respective necessary timings for the broadcast receiving modules 100a, 100b, and 100c based on the energization information table T, for example.

In the present embodiment, the calendar function module 209 that measures the current time is provided as described above. If the current time measured by the calendar function module 209 reaches the start time (refer to the third column from the right in FIG. 3) registered in the energization information table T, the controller 210 performs control for starting power supply to the broadcast receiving module 100a (100b or 100c). If the current time reaches the end time (refer to the second column from the right in FIG. 3), the controller 210 performs control for stopping power supply to the broadcast receiving module 100a (100b or 100c). By comparing the current time measured by the calendar function module 209 with the start time and the end time registered in the energization information table T, it is possible to facilitate performing energization at respective necessary timings for the broadcast receiving modules 100a, 100b, and 100c.

In the present embodiment, if the broadcast receiving module 100a (100b or 100c) measures the second current time independently of the calendar function module 209 of the device main body 200, the broadcast receiving module 100a (100b or 100c) outputs the energization control information containing the second current time as described above. Based on the second current time measured by the broadcast receiving module 100a (100b or 100c), the controller 210 of the device main body 200 performs control for correcting the first current time measured by the calendar function module 209. This makes it possible to measure the current time used to perform energization control on the broadcast receiving module 100a (100b or 100c) more accurately, for example.

In the present embodiment, an operation performed by the user (an operation with the remote-controller 300) can start or stop power supply to the broadcast receiving module 100a (100b or 100c) as described above. The controller 210 performs control for starting or stopping power supply to the broadcast receiving module 100a (100b or 100c) based on the energization control information thus received regardless of the operation performed by the user. This makes it possible to perform energization at a necessary timing for the broadcast receiving module 100a (100b or 100c) regardless of the operation performed by the user, for example.

The embodiment describes the case where the present technology is applied to the television device serving as an example of a broadcast receiver. The present technology is also applicable to another broadcast receiver (e.g., a video recording apparatus and a set-top box comprising a tuner) other than the television device.

The number of components in the embodiment may be changed as appropriate. Specifically, the embodiment describes the case where the number of broadcast receiving modules detachably attached to the device main body is three. In the present technology, the number of broadcast receiving modules may be two or less or four or more.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A broadcast receiver to which a broadcast receiving module comprising a receiver that receives a broadcast signal is detachably attached, the broadcast receiver comprising:
a power source configured to supply electric power to the broadcast receiving module; and
a controller configured to perform, when energization control information containing identification information and time information is received, energization control on the broadcast receiving module identified by the identification information based on the time information, the identification information configured to be unique to the broadcast receiving module, the time information configured to relate to power supply to the broadcast receiving module.

2. The broadcast receiver of claim 1, wherein
the broadcast receiving module comprises a plurality of broadcast receiving modules,
the energization control information comprises a plurality pieces of energization control information at least for each of the broadcast receiving modules, and
the controller is configured to perform energization control on the broadcast receiving modules individually based on the pieces of energization control information.

3. The broadcast receiver of claim 2, further comprising:
a storage module configured to store therein an energization information table in which the pieces of energization control information are registered, wherein
the controller is configured to register, when the energization control information is received, the received energization control information in the energization information table.

4. The broadcast receiver of claim 1, further comprising:
a time measuring module configured to measure a first current time, wherein
the time information contains a start time and an end time, and
the controller is configured to start energization to the broadcast receiving module when the first current time reaches the start time and to stop energization to the broadcast receiving module when the first current time reaches the end time.

5. The broadcast receiver of claim 4, wherein
the energization control information further contains a second current time, and
the controller is configured to correct, when the energization control information is received, the first current time measured by the time measuring module based on the second current time contained in the energization control information.

6. The broadcast receiver of claim 1, further comprising:
an operating module configured to allow a user to perform an instruction relating to power supply to the broadcast receiving module, wherein
the controller is configured to perform energization control on the broadcast receiving module based on the received energization control information regardless of an operation performed by the user.

7. The broadcast receiver of claim 1, wherein the time information contains time information relating to transmission and reception of individual data for each broadcast receiving module multiplexed on the broadcast signal.

8. The broadcast receiver of claim 1, wherein
the broadcast receiving module comprises a video recording module configured to record video corresponding to the broadcast signal, and
the time information contains time information relating to video recording performed by the video recording module.

9. A broadcast receiving module configured to be detachably attached to a broadcast receiver that comprises a power source, the broadcast receiving module comprising:
an output module configured to output energization control information containing identification information and time information, the identification information configured to be unique to the broadcast receiving module, the time information configured to be relate to power supply to the broadcast receiving module.

10. A method for controlling energization performed by a broadcast receiver that comprises a power source, the method comprising:
receiving energization control information containing identification information and time information, the identification information configured to be unique to a broadcast receiving module, the broadcast receiving module configured to be detachably attached to the broadcast receiver and comprising a receiver that receives a broadcast signal, the time information configured to be relate to power supply to the broadcast receiving module, and
performing, when the energization control information is received, energization control on the broadcast receiving module identified by the identification information based on the time information.
